(19) United States
(12) Patent Application Publication
(10) Pub. No.: US 2012/0324195 A1
(43) Pub. Date: Dec. 20, 2012

(54) ALLOCATION OF PRESET CACHE LINES

(76) Inventors: Alexander Rabinovitch, Kfar Yona (IL); Eliahou Arviv, Emek Aylon St. (IL); Ido Gazit, Haifa (IL); Leonid Dubrovin, Karney Shomron (IL)

(21) Appl. No.: 13/159,653

(22) Filed: Jun. 14, 2011

(51) Int. Cl. G06F 12/02

(52) U.S. Cl. 711/170; 711/E12.002

(57) ABSTRACT

An apparatus generally having a cache memory and a circuit is disclosed. The circuit may be configured to (i) parse a single first command received from a processor into a first address and a first value and (ii) allocate a first one of a plurality of lines in the cache memory to a buffer in response to the first command. The first line (a) is generally associated with the first address and (b) may have a plurality of first words. The circuit may be further configured to (iii) preset each of the first words in the first line to the first value.

### FIELD OF THE INVENTION

The present invention relates to cache initialization generally and, more particularly, to a method and/or apparatus for implementing an allocation of preset cache lines.

### BACKGROUND OF THE INVENTION

Caches are commonly used to improve processor performance in systems where data accessed by the processor is located in a slow and/or far memory (i.e., an external double data rate memory). A data cache is used to manage processor accesses to the data information in the slow/far memory. A strategy implemented in conventional data caches is to copy a line of data from the slow/far memory on any data read request from the processor that causes a cache miss.

Many applications that work with a buffer assume that the buffer is initialized with zero values in advanced of executing the application. The application subsequently writes only new or different values to the buffer. For example, the Long Term Evolution communication standard defines an application that uses a Fast Fourier Transform buffer of size 2048 long words. In operation, only 1200 long words in the buffer are written with new information while the rest of the buffer contains the zero values. Another example buffer is a residue transform buffer of 64 short words used in decoding video. An inverse zigzag application usually fills only a minor amount of the residue transform buffer with “significant” transform coefficient values while the rest of the buffer contains the zero values.

A straightforward approach to initialize a buffer in a data cache is to performer multiple reads from the slow/far memory to bring the lines associated with the buffer into the cache. Next, zero values are written into the cache lines during a buffer initialization stage. The reads produce cache misses when accessing the newly created buffer for the first time. The cache misses cause an increase in program execution cycles and increase power consumption during subsequent read bus transactions. A more advanced initialization approach prefetches data using a dedicated “dfetch” instruction. Usually, the dfetch instruction fetches a cache line from the slow/far memory to the cache memory in the background in an effort to reduce cache miss penalty cycles. However, the prefetching can delay treatment of regular cache misses and does not save power when accessing the slow/far memory. In addition, the prefetch approach complicates the code development because the dfetch instructions are executed early in the code to minimize a probability of cache stall cycles.

It would be desirable to implement a method and/or apparatus for allocation of preset cache lines.

### SUMMARY OF THE INVENTION

The present invention concerns an apparatus generally having a cache memory and a circuit. The circuit may be configured to (i) parse a single first command received from a processor into a first address and a first value and (ii) allocate a first one of a plurality of lines in the cache memory to a buffer in response to the first command. The first line (a) is generally associated with the first address and (b) may have a plurality of first words. The circuit may be further configured to (iii) preset each of the first words in the first line to the first value.

The objects, features and advantages of the present invention include providing an allocation of preset cache lines that may (i) reduce processor cycles spent initializing the buffer, (ii) avoid the use of prefetch instructions in the software code, (iii) use a special data cache command to initialize one or more cache lines, (vi) set an entire line within the cache to an initial value and/or (v) have a hardware-only implementation.

### BRIEF DESCRIPTION OF THE DRAWINGS

These and other objects, features and advantages of the present invention will be apparent from the following detailed description and the appended claims and drawings in which:

FIG. 1 is a block diagram of an apparatus in accordance with a preferred embodiment of the present invention; and

FIG. 2 is a flow diagram of an example method for allocating preset cache lines in the apparatus.

### DETAILED DESCRIPTION OF THE PREFERRED EMBODIMENTS

Some embodiments of the present invention generally use a dedicated data cache instruction (or command) and hardware-only circuitry within the cache to initialize one or more lines allocated to a buffer. Instead of fetching or prefetching values from an external memory to the data cache and then overwriting the values with zero values, one or more cache line may be directly allocated in the cache memory without accessing the external memory. The allocation may include setting (or presetting) each word in the allocated lines to a specific value. The direct allocation and presetting of the lines is generally performed by dedicated hardware logic within the cache circuit. The dedicated data cache instruction generally minimizes processor cycles commonly used to allocated lines of the cache to the buffer. The direct allocation may reduce the power spent bringing unnecessary data from the external memory to the cache. Furthermore, the dedicated data cache instruction may eliminate processor cycles that are usually spent initializing the buffer with the specific value.

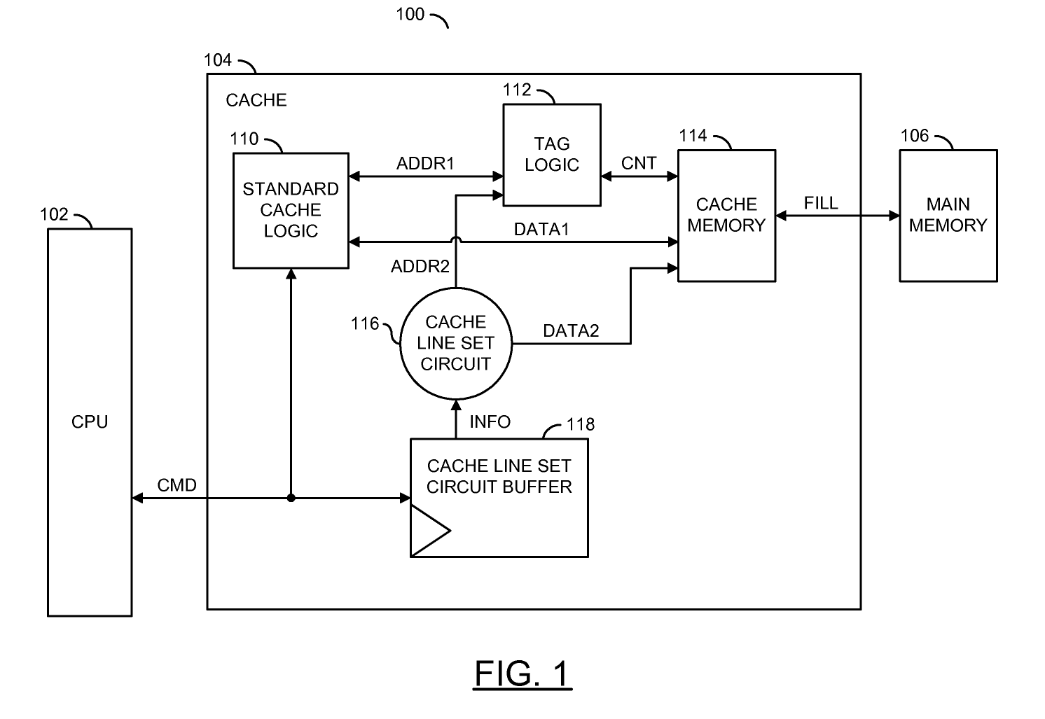

Referring to FIG. 1, a block diagram of an apparatus 100 is shown in accordance with a preferred embodiment of the present invention. The apparatus (or device or system or integrated circuit) 100 generally comprises a block (or circuit) 102, a block (or circuit) 104 and a block (or circuit) 106. The circuit 104 generally comprises a block (or circuit) 110, a block (or circuit) 112, a block (or circuit) 114, a block (or circuit) 116 and a block (or circuit) 118. The circuits 102 and 106 may represent modules and/or blocks that may be implemented as hardware, software, a combination of hardware and software, or other implementations. The circuits 104 and 110 to 118 may represent modules and/or blocks that may be implemented as hardware.

A command signal (e.g., CMD) may be exchanged between the circuit 102 and the circuits 110 and 118. The circuit 110 may generate an address signal (e.g., ADDR1) that is received by the circuit 112. A control signal (e.g., CNT) may be exchanged between the circuit 112 and the circuit 114. A data signal (e.g., DATA1) may be exchanged between the circuit 110 and the circuit 114. The circuit 114 may exchange a data signal (e.g., FILL) with the circuit 106. A signal (e.g., INFO) may be generated by the circuit 118 and received by the circuit 116. The circuit 116 may generate an address signal (e.g., ADDR2) that is received by the circuit 112. The circuit 116 may also generate a data signal (e.g., DATA2) that is received by the circuit 114.

The circuit 102 may implement a processor (e.g., a central processor unit) circuit. The circuit 102 is generally operational to execute software programs that read, write and modify data. The circuit 102 may send one or more commands (or instructions) to the circuit 104 via the signal CMD. At least one of the commands may be a unique (or custom) command used to create and initialize a buffer in the circuit 104. The unique command (e.g., a “lineset” command) may include a starting address of the buffer, an initial value to which all of the words in the buffer are initially preset and an optional range value defining how many cache lines are in the buffer.

The circuit 104 may implement a cache circuit. In some embodiments, the circuit 104 generally implements a data cache circuit. The circuit 104 may be operational to perform standard cache operations in response to one or more access (e.g., read access and/or write access) commands received from the circuit 102 in the signal CMD. The circuit 104 may also communicate with the circuit 106 to transfer write data received from the circuit 102 to the circuit 106. The circuit 104 may also receive read data from the circuit 106 when a read access by the circuit 102 results in a cache miss and/or when a fetch or prefetch command is issued by the circuit 102. In some situations, the circuit 104 may be configured to hold one or more buffers used by the software executing in the circuit 102.

The circuit 102 may include dedicated hardware circuitry that is used to allocate and initialize the buffers within the circuit 104. The dedicated hardware circuitry generally parses the lineset command received from the circuit 102 into the starting address of the buffer, the initial value and the range value. In response to the lineset command, the circuit 104 may allocated at least one line among the multiple lines in the circuit 104 to the buffer. Per the normal caching operation, the at least one line may be associated with the starting address. Each line in the cache generally contains multiple words (e.g., 8-bit words, 16-bit words, 32-bit words or the like). Once a line has been allocated, the dedicated circuitry may write the initial value into each word (or element) of the line. If the range value is greater than a single cache line, the dedicated circuitry may also allocated additional lines to the buffer and set the words within the additional lines to the initial value. After the buffer has been allocated and all of the words have been set (or preset) to the initial value, the dedicated circuitry may optionally indicate a cache write miss to cause the newly formed buffer to be copied to the circuit 106. Any normal cache write miss technique may be implemented to cause the buffer to be copied from the cache to the circuit 106.

The circuit 106 may implement a memory circuit. The circuit 106 is generally operational to store data and/or commands used by the software executed in the circuit 102. The circuit 106 may be a solid state memory (e.g., a double data rate memory). Other memory technologies may be implemented to meet the criteria of a particular application. The circuit 106 may implement another cache circuit, an external memory and/or a mass storage device. In some embodiments, the circuit 106 may be fabricated on the same die as the circuits 102 and 104. In other embodiments, the circuit 106 may be fabricated apart from the die used to fabricate the circuits 102 and 104. The circuit 106 may present data to the circuit 104 via the signal FILL in response to a cache read miss and/or a cache write miss. The signal FILL may also be used to transfer data from the circuit 104 back to the circuit 106 in response to a cache write.

The circuit 110 may implement a cache logic circuit. The circuit 110 may be operational to perform standard cache operations that respond to commands received from the circuit 102 in the signal CMD. For cache read operations, the circuit 110 may attempt to read the requested data at an address from the circuit 114. The address may be transferred to the circuit 112 in the signal ADDR1. If the data is present in the circuit 114, a cache hit is generally declared. The requested data may be copied from the circuit 114 to the circuit 110 via the signal DATA1 and presented from the circuit 110 to the circuit 102. If the requested data is not in the circuit 114, a cache miss may be declared and the requested data is fetched from the circuit 106 via the signal FILL. Once the requested data is available in the circuit 114, the circuit 110 may send a copy of the requested data to the circuit 102. For cache write operations, the circuit 110 may attempt to write data received from the circuit 102 into the circuit 114 via the signal DATA1. If the line associated with the requested write address is already present in the circuit 114, the write data may be copied into the circuit 114. Either simultaneously, or at a later time, the write data may be transferred from the circuit 114 to the circuit 106 under the control of the circuit 110. The circuit 110 generally does not respond to the lineset command used to allocated and initialize a buffer.

The circuit 112 may implement a tag logic circuit. The circuit 112 is generally operational to determine if a cache hit or cache miss has occurred in response to the address received from the circuit 110 via the signal ADDR1. When the circuit 112 receives the address, the circuit 112 may compare the address with tags for the lines of data currently held in the circuit 114. If the address matches a tag, a cache hit is declared. If the address does not match any of the tags, a cache miss is declared. The tag information is generally received from the circuit 114 via the signal CNT in a normal manner.

The circuit 112 may also be operational to respond to an address received in the signal ADDR2 from the circuit 116. The address in the signal ADDR2 may be used by the circuit 112 to allocate a single line in the circuit 114 to a buffer. The circuit 112 generally associates the single line to the address received from the circuit 116. If the circuit 112 receives a sequence of multiple addresses in the signal ADDR2, the circuit 112 may allocate multiple lines in the circuit 114, a single line being associated with each respective address.

The circuit 114 may implement a cache memory circuit. The circuit 114 is generally operational to store multiple data words. The data words may be arranged as multiple lines. Each line is generally associated with one or more addresses in the address range of the circuit 106. For example, an N-associative configuration in the circuit 114 generally means that each line within the circuit 114 may store the data words from N different addresses in the circuit 106, one address at a time. In some embodiments, the circuit 114 may be configured as a fully associative cache memory.

The circuit 116 may implement a cache line set circuit. The circuit 116 is generally operational to command the circuit 112 to allocate the one or more lines in the circuit 114 to a buffer in response to the starting address and range value received in the signal INFO. The circuit 116 may transfer the address of each line of the buffer one at a time to the circuit 112 in the signal ADDR2. Once a line in the circuit 114 has been allocated to the buffer, the circuit 116 may write the initial value to each data word in the cache line using the signal DATA2. Once all of the lines have been allocated to the buffer and all of the data words have been set to the initial value, the circuit 116 may initiate a cache write miss routine (or operation) that causes the newly initialized buffer to be copied from the circuit 114 to the circuit 106.

The circuit 118 may implement a register circuit. The circuit 118 is generally operational to recognize the lineset commands issued by the circuit 102 in the signal CMD. When a lineset command is found, the circuit 118 may store a copy of the command. The command may be parsed (or divided) by the circuit 118 into the staring address, the initial value and the range value. The starting address, the initial value and the range value may be transferred from the circuit 118 to the circuit 116 via the signal INFO.

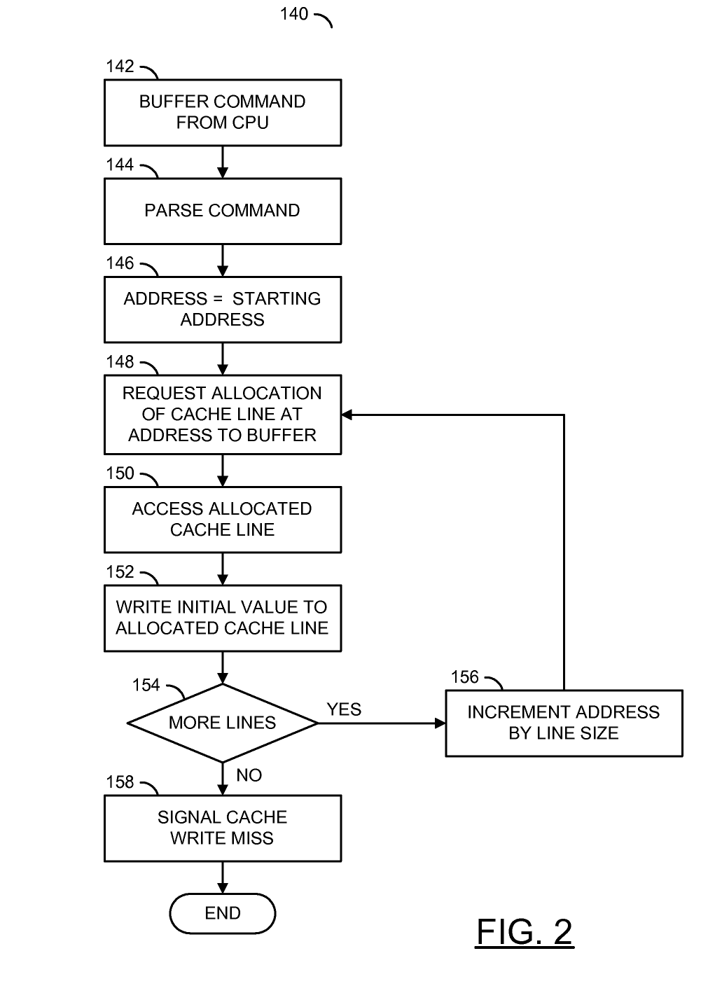

Referring to FIG. 2, a flow diagram of an example method 140 for allocating preset cache lines is shown. The method (or process) 140 may be implemented by the circuit 104. The method 140 generally comprises a step (or state) 142, a step (or state) 144, a step (or state) 146, a step (or state) 148, a step (or state) 150, a step (or state) 152, a step (or state) 154, a step (or state) 156 and a step (or state) 158. The steps 142 to 158 may represent modules and/or blocks that may be implemented as hardware.

In the step 142, the circuit 118 may recognize and buffer a lineset command received from the circuit 102. The command may be parsed by the circuit 118 in the step 144 to isolate the starting address, the initial value and (if present) the range value. The parsed information may be transferred from the circuit 118 to the circuit 116 in the signal INFO.

In the step 146, the circuit 116 may set an address value to match the starting address value received in the signal INFO. The circuit 116 may transfer the address value to the circuit 112 in the step 148 via the signal ADDR2. The transfer of the address value may request that the circuit 112 allocate an associated line in the circuit 114 to the buffer being created. The circuit 112 may respond to the allocation request by associating the address received in the signal ADDR2 with the allocated cache line.

The circuit 116 may access the allocated line within the circuit 114 in the step 150. In the step 152, the circuit 116 generally writes the initial value into each word of the allocated line. By way of example, if each cache line is multiple (e.g., 64) bytes wide and each data word in the cache line is multiple (e.g., 2) bytes wide, each cache line may contain several (e.g., 64/2=32) individually accessible words. In the example, the circuit 116 may write the initial value 32 times to fill the entire allocated line.

In the step 154, the circuit 116 may examine the range value received in the signal INFO. If the range value indicates that multiple lines should be allocated to the buffer, the circuit 116 may increment the address by the size of a line in the step 156. Returning to the example, if the initial allocated line is at an address X, the incremented address may be X+32. The method 140 may continue with the step 148 to request allocation of the next line to the buffer. The loop around the steps 148 to 156 and back to the step 148 may continue until all of the cache lines defined in the lineset command have been allocated in the circuit 114. When no more lines should be allocated and initialized, the method 140 may continue with the step 158. In the step 158, the circuit 116 may signal a cache write miss. The cache write miss may be handled in any of the available standard routines (or methods) to copy to the newly written data (e.g., the initial values) from the circuit 114 to the circuit 106. In response to a single command (e.g., the lineset command), the method 140 implemented in the hardware of the circuit 104 may allocate a buffer in the circuit 114 and preset (write) the initial value into all of the words of the buffer. Once the buffer is available in the circuit 114 (before, during or after being copied to the circuit 106), the circuit 102 may begin using the buffer.

In some embodiments, the lineset command (or instruction) may not include the range value. In such cases, each lineset command may allocate and initialize a single cache line to the buffer per the steps 142-152. To create a buffer larger than a single cache line, the circuit 102 may issue a sequence of multiple lineset commands, each with a different starting address and the same initial value. For more complicated buffer initializations, each current initial value in the sequence of commands may be different from one or more of the previous initial values. Therefore, different parts of the buffer many be initialized to different values.

Some embodiments of the present invention generally implement a dedicated (e.g., lineset) command and hardware-only logic to allocate one or more cache lines to a buffer. The hardware-only logic may also set each word (or element) in each allocated cache lines to a specific (e.g., initial) value received in the dedicated command.

Portions of the functions performed by the diagrams of FIGS. 1 and 2 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

Portions of the present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuit's such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

As would be apparent to those skilled in the relevant art(s), the signals illustrated in FIG. 1 represent logical data flows. The logical data flows are generally representative of physical data transferred between the respective blocks by, for example, address, data, and control signals and/or busses. The system represented by the apparatus 100 may be implemented in hardware, software or a combination of hardware and software according to the teachings of the present disclosure, as would be apparent to those skilled in the relevant art(s). As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the scope of the invention.

1. An apparatus comprising:
a cache memory; and
a circuit configured to (i) parse a single first command received from a processor into a first address and a first value, (ii) allocate a first one of a plurality of lines in said cache memory to a buffer in response to said first command, wherein said first line (a) is associated with said first address and (b) comprises a plurality of first words and (iii) preset each of said first words in said first line to said first value.

2. The apparatus according to claim 1, wherein said circuit is implemented using only hardware.

3. The apparatus according to claim 1, wherein said circuit is further configured to parse a range value from said first command.

4. The apparatus according to claim 3, wherein said circuit is further configured to allocate one or more additional lines of said cache to said buffer as determined by said range value.

5. The apparatus according to claim 4, wherein said circuit is further configured to preset each of a plurality of additional words in said additional lines to said first value.

6. The apparatus according to claim 1, wherein said circuit is further configured to parse a single second command received by said cache from said processor into a second address and a second value.

7. The apparatus according to claim 6, wherein said circuit is further configured to allocate a second one of said lines in said cache to said buffer in response to said second command, wherein said second line is associated with said second address.

8. The apparatus according to claim 7, wherein said circuit is further configured to preset each of a plurality of second words in said second line of said cache to said second value.

9. The apparatus according to claim 1, wherein said cache memory comprises a data cache.

10. The apparatus according to claim 1, wherein said apparatus is implemented as one or more integrated circuits.

11. A method for allocating preset cache lines, comprising the steps of:
(A) parsing a single first command received from a processor into a first address and a first value;
(B) allocating a first one of a plurality of lines in a cache memory to a buffer in response to said first command, wherein said first line (i) is associated with said first address and (ii) comprises a plurality of first words; and
(C) presetting each of said first words in said first line to said first value.

12. The method according to claim 11, wherein said parsing, said allocation and said presetting are performed using only hardware.

13. The method according to claim 11, wherein said parsing further comprises parsing a range value from said first command.

14. The method according to claim 13, further comprising the step of:
allocating one or more additional lines of said cache to said buffer as determined by said range value.

15. The method according to claim 14, further comprising the step of:
presetting each of a plurality of additional words in said additional lines to said first value.

16. The method according to claim 11, further comprising the step of:
parsing a single second command received by said cache from said processor into a second address and a second value.

17. The method according to claim 16, further comprising the step of:
allocating a second one of said lines in said cache to said buffer in response to said second command, wherein said second line is associated with said second address.

18. The method according to claim 17, further comprising the step of:
presetting each of a plurality of second words in said second line of said cache to said second value.

19. The method according to claim 18, wherein said first value is different than said second value.

20. An apparatus comprising:
means for parsing a single first command received from a processor into a first address and a first value;
means for allocating a first one of a plurality of lines in a cache memory to a buffer in response to said first command, wherein said first line (i) is associated with said first address and (ii) comprises a plurality of first words; and
means for presetting each of said first words in said first line to said first value.
